(19) United States
(12) Patent Application Publication
(10) Pub. No.: US 2009/0157494 A1
(43) Pub. Date: Jun. 18, 2009

(54) SCALABLE AUDIT-BASED PROTOCOL FOR PAY-PER-ACTION ADS

(75) Inventors: Darko Kirovski, Kirkland, WA (US); Cherian Varkey Mathew, Tiruvalla (IN); Ashwin Swaminathan, Greenbelt, MD (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/955,713

(22) Filed: Dec. 13, 2007

(51) Int. Cl. G06Q 30/00

(52) U.S. Cl. 705/14

(57) ABSTRACT

Systems and methods that account for payment of sales commission received by the merchant. An audit component simulates user behavior in purchasing items from the merchant in an advertising system, which encompasses interaction among a merchant (who advertise on websites/blogs); a trusted party (who monitors activities of the merchant), an advertisement publisher, and an advertisement consumer (e.g., buyer of the merchandise offered by the merchant).

### BACKGROUND

Electronic commerce depends in large part upon the successful and secure processing of consumer payments, wherein payment processing typically includes the process of settling charges with payment providers, such as Visa® and MasterCard®), and the like. Conventionally, a consumer browses a website and selects items for purchase by placing them in a virtual shopping cart. The consumer can subsequently supply identifying information, shipping address, as well as payment information by completing a form, for example. Such form and associated captured information can then be transmitted to a merchant.

Moreover, advertisers generally choose sites on which to purchase banner ad space based on one of two criteria. On the one hand, advertisers pay to have their ads shown to specific types of people. For example, a golf store might want to have its ads shown on a sports-related page, or to people who are likely to be interested in golf based on their browsing history. On the other hand, advertisers pay to have their ads served in such a way that they are likely to be “clicked on”, so that the user will be transported to the advertiser's web site.

One way to increase revenue generated from web advertising is thus to increase the “click through” rate of the ads shown. The click through rate of an ad is the frequency with which a user clicks on the ad to be transported to the advertiser's web site. Advertisers are attracted to sites that generate click through, and are usually willing to pay extra to those sites that can deliver increased click through. Targeted advertising is the practice of showing ads to individuals based on information about them, such as their web browsing history and demographics, to increase the click through rate.

A difficulty with targeted advertising is that advertisers familiar with the former criteria frequently specify quotas for the number of time their ads are to be shown. Sites sell ad space to many different advertisers, and contracts with all of these advertisers must be fulfilled regardless of the click through rates of the individual ads.

Regardless of which criteria is used allocation of advertisements should typically respect the capacity limitations of the ad space providers. There are limited numbers of opportunities to present ads on particular groups of cites. For example, there are a limited number of daily visits to sports-related web pages.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

The subject innovation provides for an advertising system that enables affiliates of a merchant (e.g., sales advertising agents) to account for payment of sales commission by the merchant, via employing an audit component. Such audit component simulates user behavior in purchasing items from the merchant, wherein the audit probe can be performed (e.g., automatically or manually) at different periods, to verify whether the merchant is adhering to its payment obligations for sales commission.

In general, such advertising systems encompass interaction among a merchant (who advertise on websites/blogs); a trusted party (who monitors activities of the merchant), an advertisement publisher, and an advertisement consumer (e.g., buyer of the merchandise offered by the merchant). Initially, a user or ad consumer encounters an advertisement via an ad publisher. Upon the user clicking on such displayed advertisement, a cookie is installed on the buyer side. Such cookie can indicate the product name or a set of products as well as the name of the advertiser, and is typically not deleted until specifically requested by the user. Accordingly, the cookie can specify that the buyer is directed from an ad publisher and is interested in a particular product. When such buyer purchases the product, the fee is then designated to be paid by the merchant. The cookie can also be forwarded to the trusted party and enables the proper payment to be withdrawn. Hence, the cookie can be installed to the buyer's device, wherein such cookie installation can also be checked by the audit component.

In a related aspect, the merchant can register sales templates with the trusted party, wherein such sales template can be verified not to have scripts that can illicitly veer the buyer to another payment mechanism. For example, the trusted party can check avoiding presence of scripts that place an overlay images on top of existing web pages or to place contents thereon, and hence create potential for inaccuracies for reporting actual sales. Such system further ensures scalability and mitigates risk of frauds by the parties involved.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 illustrates a block diagram of an audit component that enables advertising agents to account for payment of sales commission in accordance with an aspect of the subject innovation.

FIG. 2 illustrates a system that implements a cookie data structure in conjunction with the advertisement publisher in accordance with an aspect of the subject innovation.

FIG. 3 illustrates a particular aspect of a download for digital content via a trusted component in accordance with an aspect of the subject innovation.

FIG. 4 illustrates a block diagram of an audit-based protocol for a pay-per-action (PPA) advertisement system in accordance with a particular aspect of the subject innovation.

FIG. 5 illustrates a related methodology of auditing a merchant in accordance with an aspect of the subject innovation.

FIG. 6 illustrates a related methodology of accounting for sales transaction of a merchant in accordance with an aspect of the subject innovation.

FIG. 7 illustrates a cookie context data storage structure that can be employed in conjunction with an audit component of the subject innovation.

FIG. 8 illustrates a system that facilitates the display of content-targeted advertisements in accordance with an aspect of the subject innovation.

FIG. 9 illustrates a schematic block diagram of a suitable operating environment for implementing aspects of the subject innovation.

FIG. 10 illustrates a further schematic block diagram of a sample-computing environment for the advertising system of the subject innovation.

### DETAILED DESCRIPTION

he various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

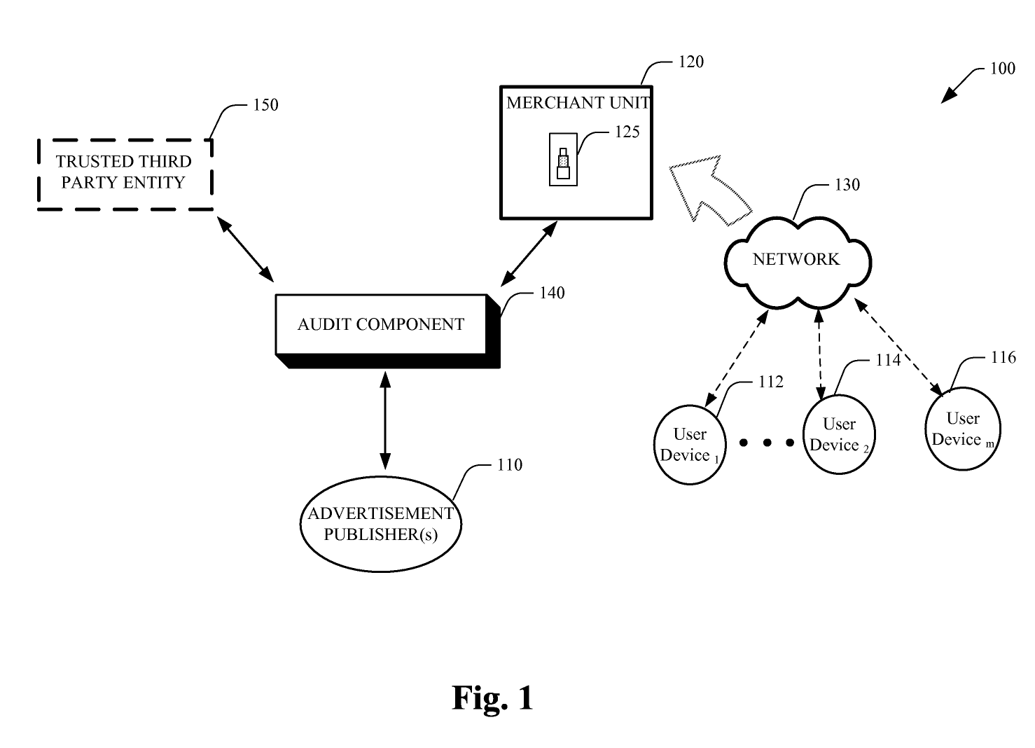

FIG. 1 illustrates a block diagram of an audit component 140 that enables accounting for revenues generated from sales of an item purchased by a user from an advertisement. The audit component 140 simulates user behavior in purchasing items from the merchant unit 120, wherein the audit probe can be performed manually or automatically at different periods, to verify whether the merchant unit 120 is adhering to its payment obligations for sales commission, which it has agreed to provide to affiliates and agents such as advertisement publisher(s), for example.

The audit component 140 is part of an advertising system 100 that encompasses interaction among a merchant unit 120 (which advertises on websites/blogs thru the Internet, and can also include a point of sale 125, for example); a trusted party entity 150 (which monitors activities of the merchant unit 120), an advertisement publisher 110, and advertisement publishers 110 that enter into agreements with the merchant unit 120 for display of advertisement content, in return for a fee. The user (e.g., buyer of the merchandise) can view advertisement over a presentation component when visiting a website, for example. Accordingly, a user or ad consumer encounters an advertisement via the advertisement publisher 11 0. For example, the advertisement publisher 110 can have multiple display segments of a webpage positioned at predetermined locations of a display, wherein users (e.g., purchasers of a product) are likely be able to see and/or hear presented advertisement tied to the sale of a product by the merchant unit 120. The predetermined locations can include spaces that optimize visibility likelihood for advertisements on the display screen, for example.

Such advertisement can also be displayed to the users based on a context analysis for the customer (e.g., activities performed via user devices 112, 114, 116, prior web pages visited, and the like) Upon viewing a desired advertisement on the display screen, the user can click on such displayed advertisement, wherein a cookie (not shown) can be installed on the buyer side. Such cookie can indicate the product name or a set of products as well as the name of the advertiser, and is typically not deleted until specifically requested by the user. Accordingly, the cookie can specify that the buyer is directed from an ad publisher and is interested in a particular product. Any time, such buyer purchases the product, the fee is designated to be paid by the merchant.

A user(s) or customer can employ a user device 112, 114, 116 and a network 130 to access the merchant unit 120. The user devices 112, 114, 116 can also be part of a network (e.g., wireless network), such as a system area network or other type of network, and can include several hosts, (not shown), which can be personal computers, servers or other types of computers. Such host generally can be capable of running or executing one or more application-level (or user-level) programs, as well as initiating an I/O request (e.g., I/O reads or writes). In addition, the network can be, for example, an Ethernet LAN, a token ring LAN, or a Wide Area Network (WAN). Moreover, such network can also include hardwired and/or optical and/or wireless connection paths. The connections can be shared among a plurality of the user devices 112, 114, 116 that can purchase digital files from the merchant unit 120. Likewise, the user devices 112, 114, 116 can include intelligent devices such as personal computers, workstations, televisions, telephones, and the like for example. Moreover, the wireless network 130 can further include one or more input/output units (I/O units), wherein such I/O units can includes one or more I/O controllers connected thereto, and each of the I/O can be any of several types of I/O devices, such as storage devices (e.g., a hard disk drive, tape drive) or other I/O device. The hosts and I/O units and their attached I/O controllers and devices can be organized into groups such as clusters, with each cluster including one or more hosts and typically one or more I/O units (each I/O unit including one or more I/O controllers). The hosts and I/O units can be interconnected via a collection of routers, switches and communication links (such as wires, connectors, cables, and the like) that connects a set of nodes (e.g., connects a set of hosts and I/O units) of one or more clusters.

Moreover, the wireless communication network 130 can be cellular or WLAN communication network; such as Global System for Mobile communication (GSM) networks, Universal Mobile Telecommunication System (UMTS) networks, and wireless Internet Protocol (IP) networks such as Voice over Internet Protocol (VoIP) and IP Data networks The user device 112, 114, 116 can be a hand-held wireless communication device that can communicate with a wireless communication network, (e.g. wireless communication network 130) to upload and download purchased digital information, via a cellular access point and/or via a wireless access network (WLAN) access point, such as a cellular base station, mobile switching center, 802.11x router, 802.16x router and the like. Further examples of the portable user device 112, 114, 116 can include a cellular communication device, a multi-mode cellular device, a multi-mode cellular telephone, a dual-mode cellular device, a dual-mode cellular/WiFi telephone, or like cellular and/or combination cellular/fixed internet protocol (IP) access devices.

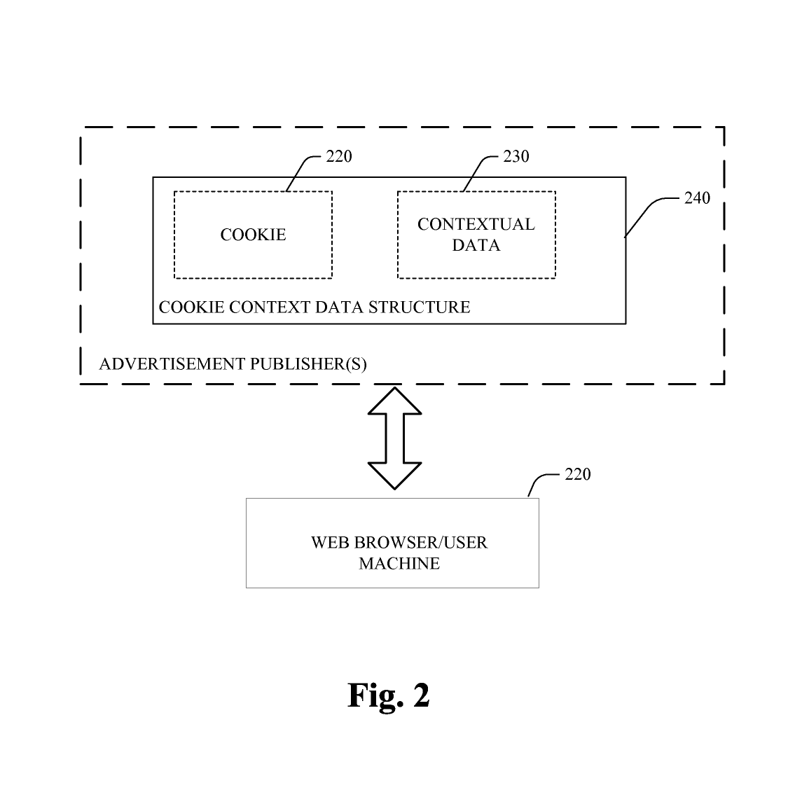

FIG. 2 illustrates a system 200 that installs cookies on the user side when the user clicks on a displayed advertisement. In general, such “cookie” can be in a form of data passed between a web browser and a server. The cookie is generally stored on a client system (e.g., user machine) by a server. A cookie stored on a user's system can be sent by the user's web browser to a server along with a request for a particular web page, which designates an item to be purchased. Typically, when a user visits a web page, via Hyper Text Transfer Protocol (http), a connection between the user's browser and a server is opened, and data or code is downloaded to the user's browser and the connection is closed. Such installed cookie can be as one or more file(s) typically stored (e.g., set) on the client system (e.g., user's personal computer) by a server. A cookie stored on a user's system can be sent by a user's web browser (e.g., replayed) to a server (e.g., associated with the cookie) along with a request for a particular web page. The cookie context data structure 210 includes a cookie 220 and contextual data 230. The cookie 220 can include, for example, the name of the cookie, the value of the cookie, the expiration date of the cookie, the path the cookie is valid for, the domain the cookie is valid for and/or the need for a secure connection to exist to use the cookie. The cookie 220 can provide client-related (e.g., user) information to a merchant server (not shown), wherein the contextual data 230 can include application dependent context, such as for example, information associated with the context in which the cookie 220 was stored (e.g., set by a server). The contextual data 230 is generally stored by a client system (not shown) and can be based, at least in part, upon information received from a server (not shown). For example, the contextual data 230 can store information associated with the cookie 220 (e.g., user, domain and/or domain/path combination of a top-level document accessed when the cookie was set or modified, embedded URL). Moreover, the stored contextual data can be generally a subset of available context relating to the cookie 220. Such subset can be selectively chosen so as to facilitate optimization of cookie handling.

It is to be appreciated that while cookie 220 and contextual data 230 have been depicted as located within the cookie context data structure 210, the cookie 220 and contextual data 230 can alternatively be stored in separate physical location(s) within a user system (not shown) (e.g., as separate files) with the cookie context data structure 210 facilitating association of the cookie 220 with contextual data 230. For example, the contextual data 230 can be compared to the context of a particular network resource and/or session. The results of the comparison can be employed, for example, in connection with cookie handling (e.g., replay cookie, suppress cookie).

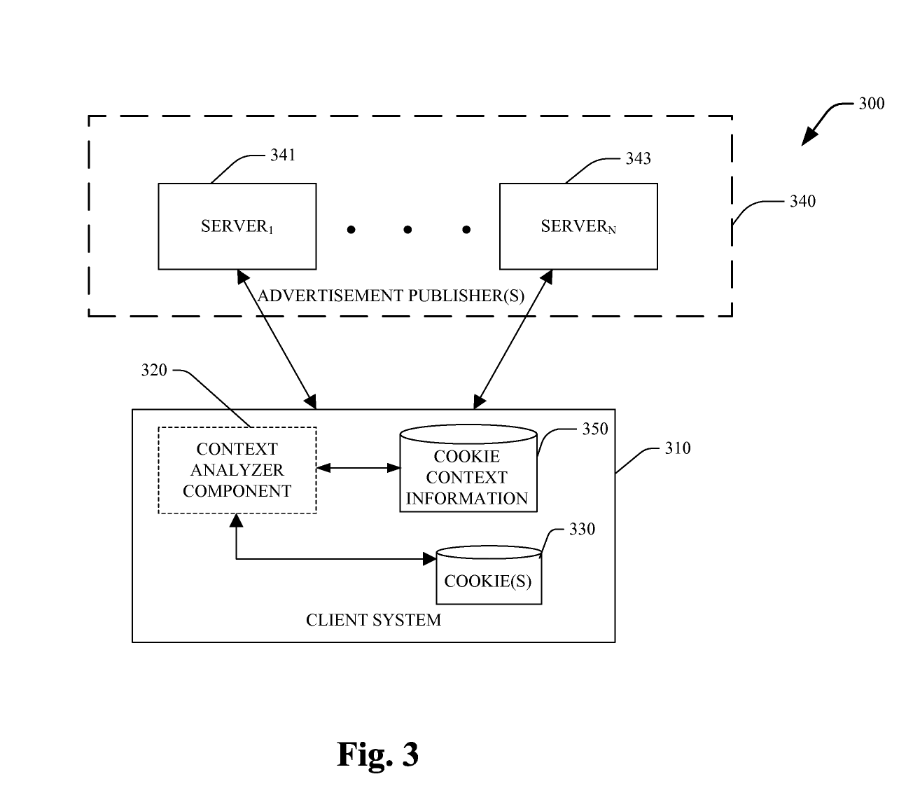

FIG. 3 illustrates a system 300 for installation of cookies on a user (e.g., buyer or client) side in accordance with an aspect of the subject innovation. The system 300 includes a first server 341 through a server 343, (1 to N, N being an integer). The servers 341 through 343 can be referred to collectively as the server 340. The system 300 further includes a client system 310 having a context analyzer 320, cookie(s) 330 and cookie context information 350.

The server 340 can be a web server that sends a web page associated with a merchandise for sale in response to a request from the client system 310. For example, the server 340 and the client system 310 can establish an HTTP session and transfer information (e.g., a web page) via HTTP protocol, wherein included in the information received from the server 340 can be a cookie (not shown). The client system 310 is a computer system facilitating sending to and/or receiving information from the server 340. For example, the client system 310 can include a web browser (not shown) facilitating navigation and/or communication, for example, on the Internet utilizing one or more protocol(s).

The cookie(s) 330 can include a set of one or more cookies received from the server 340. A cookie can include the name of the cookie, the value of the cookie, the expiration date of the cookie, the path the cookie is valid for, the domain the cookie is valid for and/or the need for a secure connection to exist to use the cookie. A cookie can further provide client-related (e.g., user) information to the server 340 and is generally received from the server 340.

The cookie context information 350 can store contextual information associated with one or a plurality of cookie(s). For example, the cookie context information 350 can store information (e.g., user, domain and/or domain/path combination of a top-level document accessed when the cookie was set or modified) in which a cookie was originally received (e.g., set) and/or most recently modified.

The context analyzer component 320 can facilitate storage of contextual information associated with a cookie. For example, upon receipt of a cookie from the server 340, the context analyzer component 320 can store contextual information associated with the cookie (e.g., user, domain and/or domain/path combination of a top-level document accessed when the cookie was set or modified) in the cookie context information 350. Furthermore, the context analyzer component 320 can facilitate replaying and/or suppressing of cookie(s) based, at least in part, upon contextual information stored in the cookie context information 350. By employing such cookies, transactions among a trusted party (who monitors activities of the merchant), an advertisement publisher, and an advertisement consumer (e.g., buyer of the merchandise offered by the merchant) can be tracked. The trusted party can host sweepstakes and/or other type of incentive based user-initiated audits to achieve similar results in enforcing pay-per-action (PPA) ads. Moreover, advertisement publishers can sign up for auditors, such that a publisher can selectively check merchants (e.g., checking other merchants and not checking a merchant associated therewith).

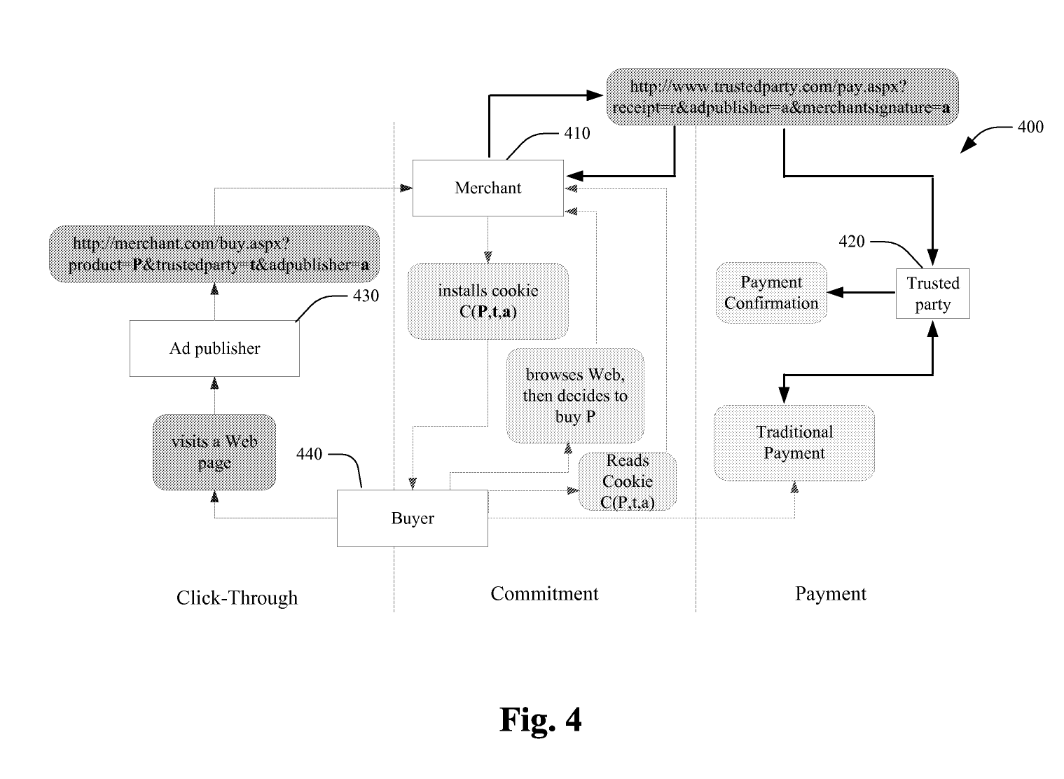

FIG. 4 illustrates a block diagram of an audit-based protocol for a pay-per-action (PPA) advertisement system 400 in accordance with a particular aspect of the subject innovation. The merchant “m” 410 markets a specific product P, and given a cost P0 of obtaining P, the objective of m is to reduce cost of marketing PM for a fixed selling price PS governed by fixed product demand. Such maximizes its profit m=PS−P0−PM, wherein it can be assumed that m could use malicious action to boost its profits.

Likewise, the trusted party “t ” 420 can set up advertisement contracts with merchant(s) 410 and ad publishers 430. For example, a plurality of techniques for ad placement can be employed to optimize click-through and/or conversion rates, wherein the trusted party 420 is enabled to handle payments to merchant m 410. It is to be appreciated that in a general system a separate trusted entity can also perform such task, provided that it is not financially controlled by m. Such trusted party 420 can be paid per transaction a fee ct for handling the transaction. Accordingly, the objective of t is to maximize the collected fees while keeping its operating costs low. Such costs stem from the traffic imposed upon its servers for each executed transaction, for example.

Ad Publisher 430 (designated as “a”) can present an advertisement on its Web page. Such ad can be presented as a link over an arbitrary multimedia content that connects to merchant's sales Web page. The ad publisher 430 can be paid a fee ca every time a user clicks through its advertisement and purchases P at merchant's Web site. Accordingly, the objective of the publisher is to maximize its revenue, wherein it can be assumed that “a” can engage in malicious activity to boost its revenue (e.g., in conventional pay-per-click—PPC model, click fraud is one type of such activity).

The Buyer 440 can be designated as “b”, which resembles the prospective buyer of P. Such buyer learns about the prospect of buying P from “m” while visiting the ad at “a”. The buyer aims to buy P at the lowest price possible—and thus, is willing to follow any offer (even malicious with respect to “a” and/or “t”) with a lower price. In one particular example, the subject innovation enables a protocol for a PPA advertisement system, which consists of four stages: Click-Through, Commitment, Purchase, and Audit.

Click Through

The buyer b visits a Web site published by a. Ads on this Web site could be served by a and/or t. An ad can typically present an arbitrary multimedia content (text, image, video, etc.), which is hyper-linked to a merchant's Web page. The hyperlink can contain the data about the parties responsible for the click-through, such as: the identity of the publisher a, the identity of the trusted party t, and the advertised item of interest P. It is to be appreciated that the contract between m and a can be such that a special offer (e.g., coupon, rebate, and the like) is presented as a marketing incentive for b to pursue the click-through. Such information can be presented to b in form of a message and an associated cryptographic signature signed by m. No restriction is typically posed on the type of offers that m can present to b. For example, limited time offers can be organized by timing offers at Web site of “a”; early-bird specials can be resolved using customer registration systems. In general, the proposed ad protocol is orthogonal to existing sales mechanisms. An example of an ad hyperlink can include: http://www.merchant.com/buy.aspx?productid=24& trustedpartyid⁼34&publisherid=1034 where an advertisement for a product with an identifier 24 is published (served) on ad publisher's Web page by a trusted party with an identifier 34. The identifier of the ad publisher is 1034. The trusted party identifier is used by m to learn which trusted party was responsible for this click-through. At this point, m stores a cookie on b's computer that identifies the trusted party, the ad-publisher, and the offer presented by m for P. This information is used later in the protocol in case b decides to make a purchase.

Commitment

During such stage it can be assumed that b desires to commit to purchasing P at m's Web site. From the perspective of the buyer such action can be typically performed by clicking on the “add to-cart” button followed by the shopping cart check out. Then, m reads its cookie from b's client and forms a transaction receipt based upon the presented offer for P, and the identities of b (this identity is obtained through a customer registration process), t, and a. The merchant then forwards both the receipt as well as b to the trusted party that handles the payment. The receipt can include a message that includes: the amount that b has to pay, the identity of the publisher “a”, in form of a unique transaction identifier, and the like. The message can be signed by m to recognize its approval of the transaction and eliminate repudiation and/or malicious alterations.

The user can be directed to a URL similar to:

$$\frac{http \text{://} www . trustedparty . com \text{/} pay . aspx ? amount = 99.99 \&}{publisherid = 1034 \& merchantsignature = a 3 h 49 hba 5.}$$

Two actions that can potentially harm protocol's participants can be examined, wherein in the first action, before making a purchase b deletes the cookie that m stored after b's first visit to m's Web page dedicated to selling P. Such activity can adversely influence all participants—except potentially m—wherein, b can lose the offer from m stored in the cookie and t and “a” would not profit from an executed transaction. Since the cookie directly benefits b, and b is the only party responsible for storing the cookie, it can be assumed that in the vast majority of situations the cookie at b's client will not be deleted during an on-going PPA.

In the second action, m decides to disobey the protocol using a malicious action similar to “hit shaving.” Here m can perform several malicious actions with a simple target to avoid reporting a PPA to t and a by presenting an alternate offer to b that circumvents the existing protocol. Moreover, because both “a” and “t” are not directly involved in the communication between m and b, m has all the freedom to perform such an activity. Accordingly, an audit protocol performed by t that relies on the invariance of “permissible” sales HTML templates can address such problem.

Payment

In this stage, which occurs on t's transaction server, b authorizes payment to t, which then sends the agreed upon fee, Ca, to a, withholds t's own fee Ct, and sends the remaining balance to m. The immediate objective for t is to assure m that b has completed payment so that m can follow up with delivering P. Payments may not be instantaneous; rather, they may be accumulated and paid using a traditional accounting system. It is to be appreciated that the entity t need not be a single entity; individual actions performed by t can be done by a set of trusted entities. In general, an arbitrary efficient payment-outsourcing system can further be employed for managing fund transfers among protocol participants. Moreover, since the trusted party knows the cost of P, the fees paid to t and “a” can be defined as a fraction of the cost of P rather than a flat fee.

Audit

One challenge is that m can perform an arbitrary “hit shaving” action towards “a” and “t” without their knowledge. For example, m could present an alternate offer to buyers forwarded to m's Web site by “a”. If the offer is at equal or better price than the one presented in the ad posted at a's Web site, and it can be assumed that b will participate in such a transaction as the advertising process is transparent. The ad publisher or the trusted party can analyze m's offer pages for alternate offers. However, such can be a rather difficult task as m can employ sophisticated scripts to mislead such a tool. For example, a script that overlays an image over a traditional selling Web-page with an image of a Web-page presenting an alternative offer can be difficult to analyze in an automated fashion.

The subject innovation employs a solution to this problem in the form of an audit. When m and a sign an advertising contract via t as an intermediary, m agrees to employ a set of arbitrary HTML templates for Web-page design at its Web site. At the time of signing the contract, “a” and/or “t” could inspect the template-set and ascertain its trustworthiness, e.g., lack of potentially malicious embedded scripts. Once such a template-set is agreed upon, in response to a customer forward from an ad publisher, m can present its offer as well as all related shopping pages and cookies using the approved template-set. In addition, the merchant is able to change design templates throughout the advertising campaign as long as the new design sets are also authorized by “t” and/or “a”. In response to the standardization of the shopping interface at m's Web site, the trusted party t can run an automated auditing script with an aim to simulate a prospective buyer and verify m's responses to buyer's shopping input. To achieve such objective, the auditing script can perform the following acts:
A click-through of an ad displayed at Web site of “a” can be simulated using an http request.
Since the pages on Web-site of “m” follow a known template, it can be readily followed through the buying procedure by sending corresponding http requests.
Finally, m typically follows up with a sequence of actions that takes the “simulated buyer” to t's payment Web-page. At this point t verifies that a payment request has been submitted to its transaction server by m that conforms to the agreed protocol.

In order to simulate prospective buyers “t” should typically generate the audit http requests from IP addresses that could not be traced to t, rather it can be difficult to ascertain whether the requests come from an automated or human “buyer.” Such can be performed by employing dynamically obtained IP addresses that belong to large ISP providers. To cover the entire space of potential buyers, audits from arbitrary static IP addresses can be launched. By requiring t install an auditing client such as a screen-saver on computers of users willing to participate in the audit campaign. Since m can only choose to probabilistically “cheat” with its offers to buyers, a relatively small number of audits should proportionally reduce the chances of m's malicious behavior remaining undetected. Moreover, the increase of traffic to m's Web-site due to the audits can be relatively small as an auditing system with realistic success rates can generate only dozens of click-throughs per advertisement.

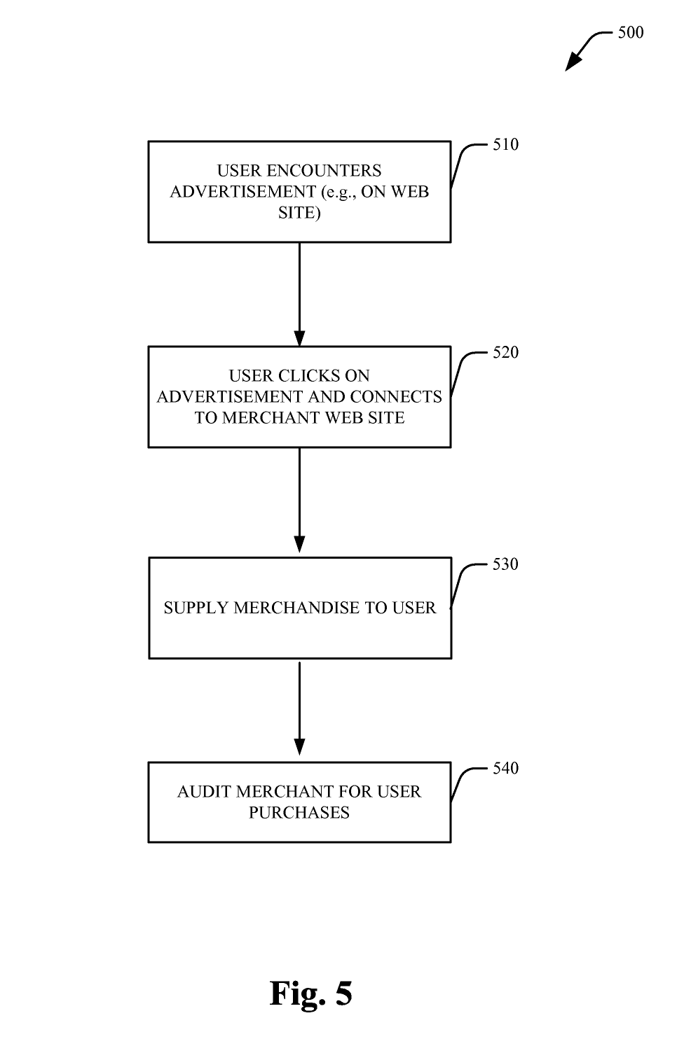

FIG. 5 illustrates a related methodology 500 of auditing a merchant in accordance with an aspect of the subject innovation. While the exemplary method is illustrated and described herein as a series of blocks representative of various events and/or acts, the subject innovation is not limited by the illustrated ordering of such blocks. For instance, some acts or events may occur in different orders and/or concurrently with other acts or events, apart from the ordering illustrated herein, in accordance with the innovation. In addition, not all illustrated blocks, events or acts, may be required to implement a methodology in accordance with the subject innovation. Moreover, it will be appreciated that the exemplary method and other methods according to the innovation may be implemented in association with the method illustrated and described herein, as well as in association with other systems and apparatus not illustrated or described. Initially and at 510, a user or ad consumer encounters an advertisement via an ad publisher (e.g., the user visiting a site and viewing an ad for a merchandise or digital content). Next, and at 520 the user can click on the advertisement and be connected to the merchant site. At 530 the user can purchase the required digital content thru the merchant site. At 540, the merchant can be audited for sales performed and merchandise being sold.

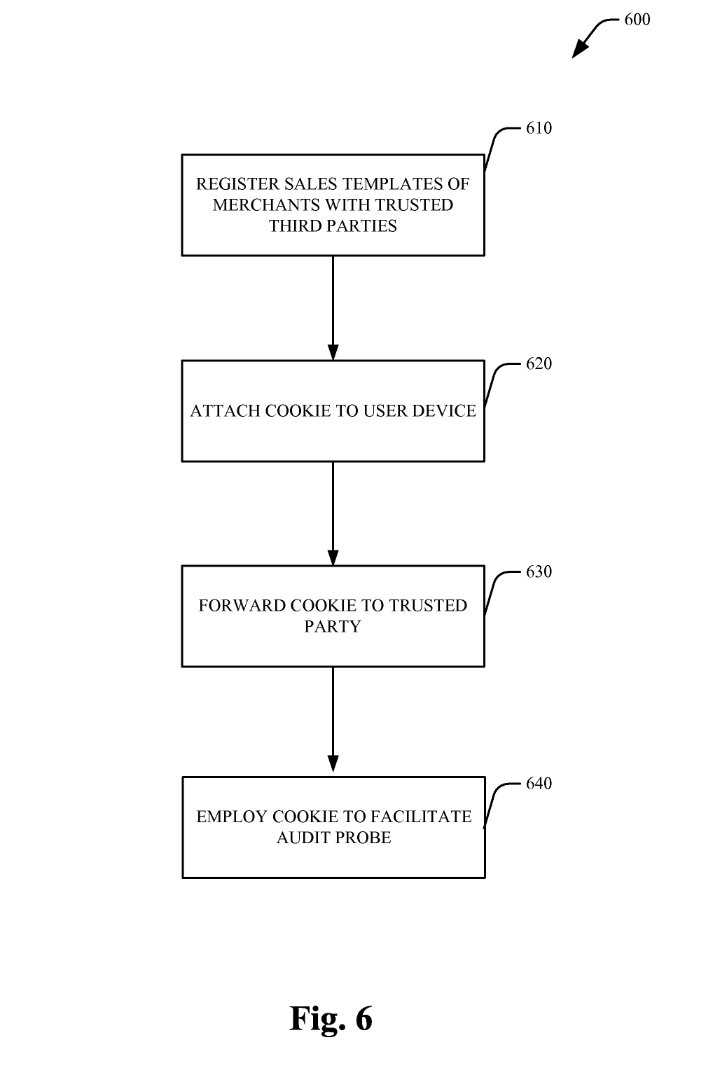

FIG. 6 illustrates a related methodology 600 of accounting for sales transaction of a merchant, according to an aspect of the subject innovation. Initially and at 610, sales templates of merchants can be registered with the trusted party, wherein such sales template can be verified not to have scripts that can illicitly veer the buyer to another payment mechanism. For example, the trusted party can check avoiding presence of scripts that place an overlay images on top of existing web pages or to place contents thereon, and hence create potential for inaccuracies for reporting actual sales. Upon being re-directed to the merchant's site for a view of the sales template via a click through, a cookie is installed on the buyer side at 610. As explained earlier, such cookie can indicate the product name or a set of products as well as the name of the advertiser, and is typically not deleted until specifically requested by the user. At 620, the cookie can be forwarded to a trusted third party, to designate that the buyer is directed from an ad publisher and is interested in a particular product. When such buyer purchases the product, the fee is designated to be paid by the merchant to facilitate a probe at 630.

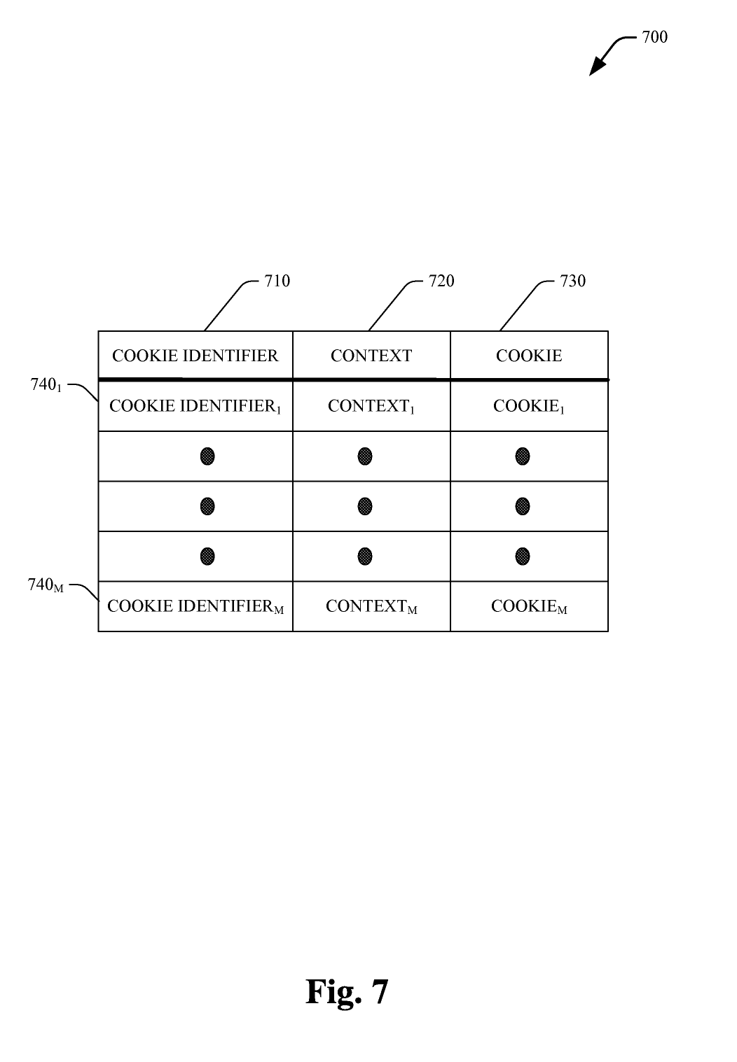

FIG. 7 illustrates a cookie context data storage structure 700 that can be employed in conjunction with an audit component of the subject innovation. The cookie context data storage structure 700 includes a cookie identifier field 710, a context field 720 and a cookie field 730. Furthermore, the cookie context data storage structure 700 includes a first cookie context entry 740₁ through an M^{th} cookie context entry 740_{M}, (where M is an integer.)

The cookie identifier field 710 facilitates identification of cookie(s). For example, the cookie identifier field 710 can be a name of a cookie and/or a unique identifier associated with a cookie. The context field 720 facilitates associating context, if any, with a cookie. For cookie(s) not having any associated context, the context field 720 can be null and/or an indicator that the cookie has no associated context. Such cookie field 730 provides information related to the cookie. For example, the cookie field 730 can provide the filename of the cookie. Alternatively, the cookie field 730 can include the cookie itself The cookie context entry 740 can include information associated with cookie(s) and/or context of cookie(s). For example, the cookie context data storage structure 700 can have cookie context entries 740 for substantially all cookies located within a client system (not shown). Cookies without associated context can have an indication as such in the context field 720. Alternatively, the cookie context data storage structure 700 can have entries for substantially all cookies having context located within a client system (not shown). The various fields (710, 720, 730, 740) have been depicted as singular fields for sake of brevity and ease of understanding. It is to be appreciated that one or more or these fields could include a plurality of sub-fields. For example, context₁ field could include N number of sub-context fields (N being an integer)- each sub-context field including context related information regarding cookie₁. Likewise, the structure 700 can be organized in a relational form (e.g. relational database), as to associate a particular field(s) and sub-field(s) to other field(s).

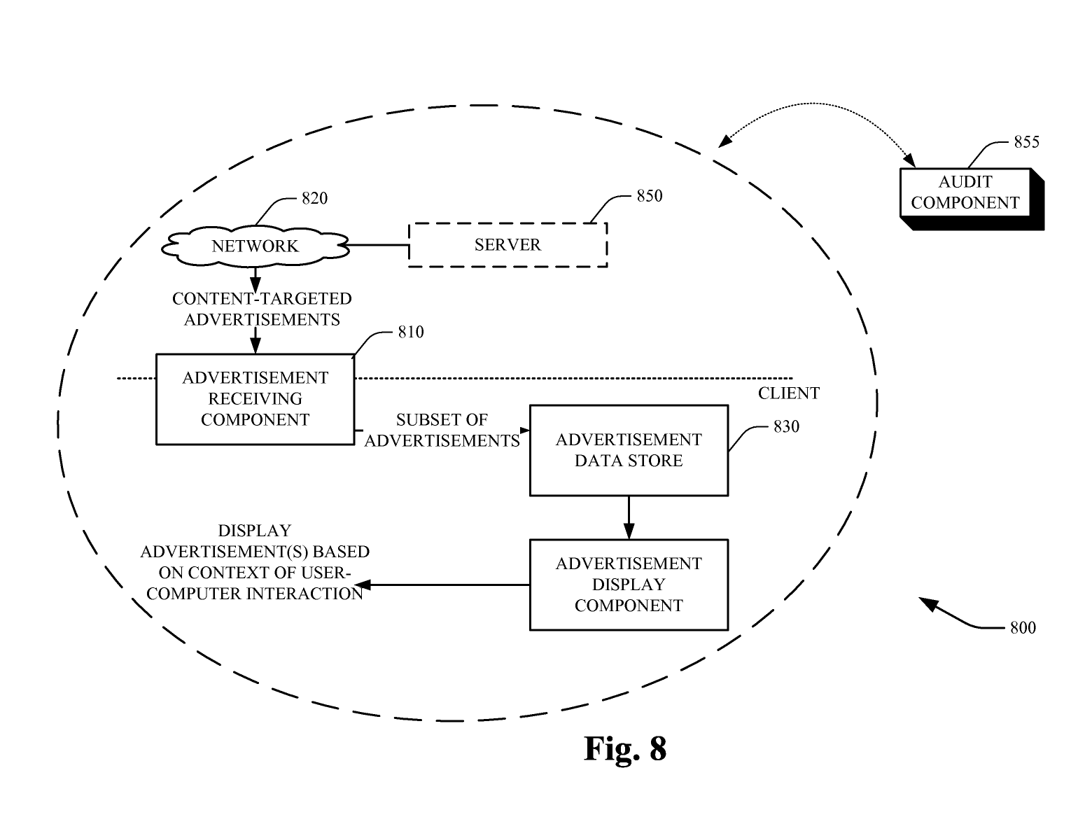

FIG. 8 illustrates a system 800 that facilitates the display of content-targeted advertisements in accordance with an aspect of the subject innovation. The system 800 includes an advertisement receiving component 810 that can receive one or more content-targeted advertisements from a network 820 or server 850. A subset of the advertisements can be stored on a client such as in an advertisement data store 830. An advertisement display component 840 can display at least one advertisement from the subset of advertisements as a function of context relating to a user-computer interaction. Moreover, a plurality of advertisements can be downloaded and stored on the user's computer (client). When the user has accessed a document or file, the client can screen the document and run a content-targeted advertising process to determine and display the most relevant advertisements—based on the content of the user's document. The user's click of an advertisement can trigger the server to access and send more ad-related information to the user based on the click data.

For some applications in which data or content is stored on a server, the content can actually be stored in encrypted form on the server. The client maintains possession of the key so that the network 820 or server 850 connected to the network does not see the user's private content, and yet can still conduct content-targeted advertising for content stored on the server. Moreover, the audit component 855 simulates user behavior in purchasing items from the merchant, wherein the audit probe can be performed automatically at different periods, to verify whether the merchant is adhering to its payment obligations for sales commission.

As used in herein, the terms “component,” “system” and the like are intended to refer to a computer-related entity, either hardware, a combination of hardware and software, software or software in execution. For example, a component can be, but is not limited to being, a process running on a processor, a processor, an object, an instance, an executable, a thread of execution, a program and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner. It is to be appreciated that a myriad of additional or alternate examples could have been presented, but have been omitted for purposes of brevity.

Furthermore, all or portions of the subject innovation can be implemented as a system, method, apparatus, or article of manufacture using standard programming and/or engineering techniques to produce software, firmware, hardware or any combination thereof to control a computer to implement the disclosed innovation. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

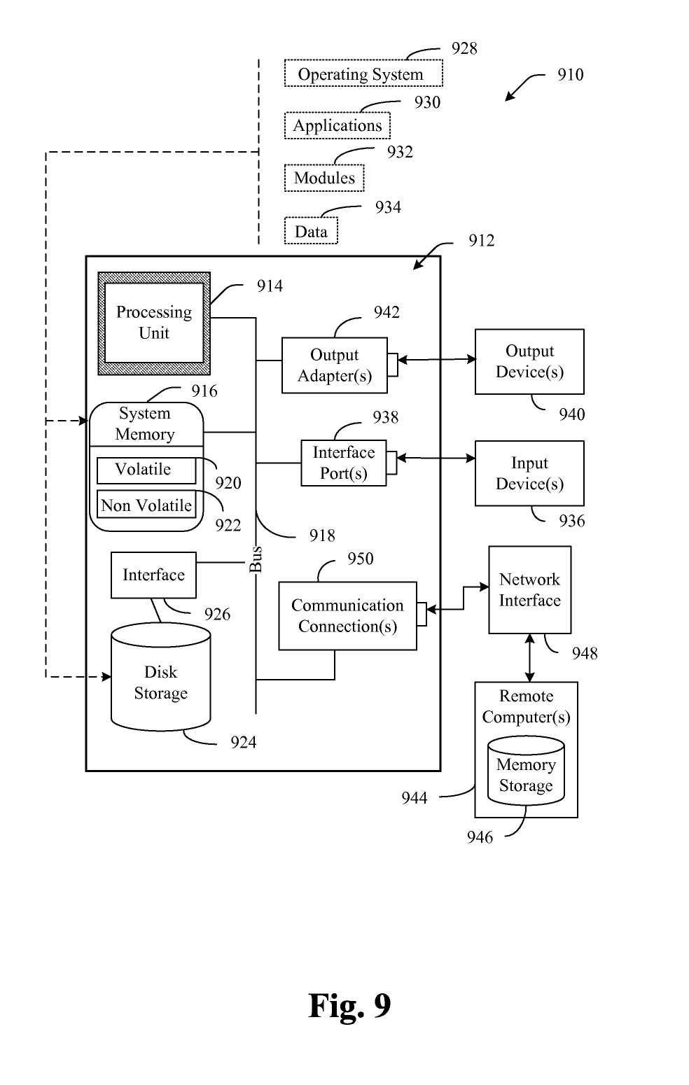

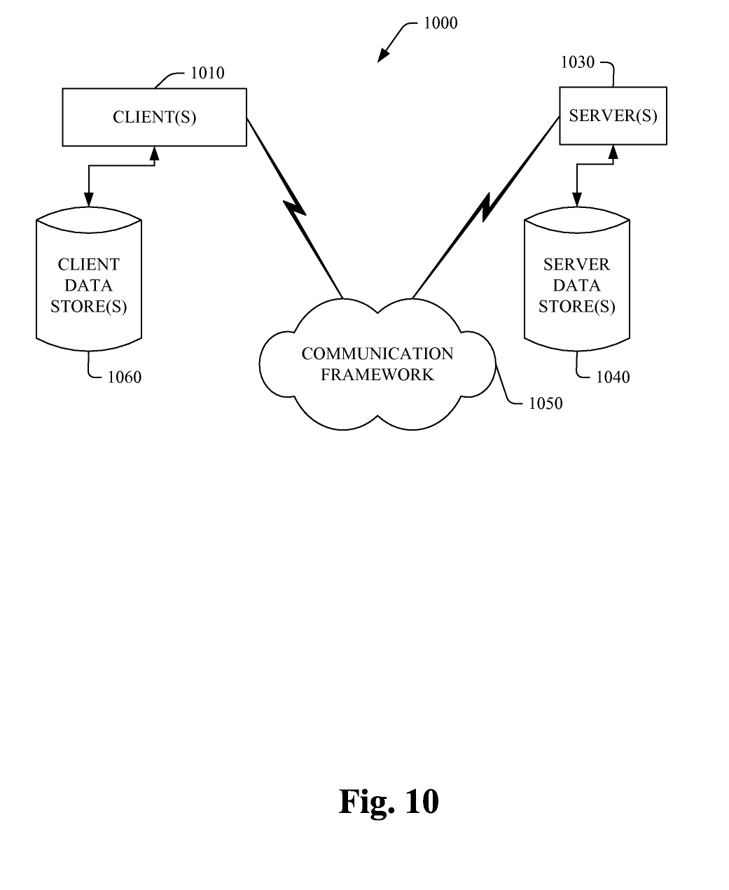

In order to provide a context for the various aspects of the disclosed subject matter, FIGS. 9 and 10 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the innovation also may be implemented in combination with other program modules. Generally, program modules include routines, programs, components, data structures, and the like, which perform particular tasks and/or implement particular abstract data types. Moreover, those skilled in the art will appreciate that the innovative methods can be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the innovation can be practiced on stand-alone computers. In a distributed computing environment, program modules may be located in both local and remote memory storage devices.

With reference to FIG. 9, an exemplary environment 910 for implementing various aspects of the subject innovation is described that includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/non-removable, volatile/non-volatile computer storage media. FIG. 9 illustrates a disk storage 924, wherein such disk storage 924 includes, but is not limited to, devices like a magnetic disk drive, floppy disk drive, tape drive, Jaz drive, Zip drive, LS-60 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that various components described herein can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940 that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

FIG. 10 is a schematic block diagram of a sample-computing environment 1000 that can be employed as part of a processing system of payment for downloaded digital content in accordance with an aspect of the subject innovation. The system 1000 includes one or more client(s) 1010. The client(s) 1010 can be hardware and/or software (e.g., threads, processes, computing devices). The system 1000 also includes one or more server(s) 1030. The server(s) 1030 can also be hardware and/or software (e.g., threads, processes, computing devices). The servers 1030 can house threads to perform transformations by employing the components described herein, for example. One possible communication between a client 1010 and a server 1030 may be in the form of a data packet adapted to be transmitted between two or more computer processes. The system 1000 includes a communication framework 1050 that can be employed to facilitate communications between the client(s) 1010 and the server(s) 1030. The client(s) 1010 are operatively connected to one or more client data store(s) 1060 that can be employed to store information local to the client(s) 1010. Similarly, the server(s) 1030 are operatively connected to one or more server data store(s) 1040 that can be employed to store information local to the servers 1030.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims.

Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer implemented system comprising:
an advertising system that pays sales commission from a merchant to an advertisement publisher; and
an audit component that audits the merchant for sales generated from the advertisement publisher via cookies attachable to a device of a buyer.

2. The computer implemented system of claim 1 further comprising a trusted party that facilitates the audits.

3. The computer implemented system of claim 2 further comprising sales templates that are registerable with the trusted party.

4. The computer implemented system of claim 3, the sales templates checked for scripts that guides buyers to other payment mechanisms.

5. The computer implemented system of claim 4, an advertisement displayable based on context analysis.

6. The computer implemented system of claim 5, the cookie further comprising context data structure.

7. The computer implemented system of claim 6, the context data structure includes application dependent context.

8. The computer implemented system of claim 1 further comprising a contextual analyzer component that facilitates replaying or suppressing cookies.

9. The computer implemented system of claim 1 further comprising a display component that displays a subset of advertisement as a function of context relating to user-computer interaction.

10. A computer implemented method comprising:
directing a user to a merchant site via an advertising publisher;
monitoring activities of the merchant to verify adherence to sales obligations; and
paying the advertising publisher.

11. The computer implemented method of claim 10 further comprising simulating activities of a user.

12. The computer implemented method of claim 10 further comprising installing a cookie on a user side.

13. The computer implemented method of claim 12 further comprising checking attachment of the cookie via an audit component.

14. The computer implemented method of claim 13 further comprising registering a sales template of the merchant with the audit component.

15. The computer implemented method of claim 14 further comprising checking for presence of scripts that place an overlay image on top of web pages.

16. The computer implemented method of claim 15, the monitoring act further comprising automatically auditing the merchant.

17. The computer implemented method of claim 16 further comprising clicking on an advertisement by the user.

18. The computer implemented method of claim 14 further comprising forwarding the cookie to the audit component.

19. The computer implemented method of claim 18 further comprising paying for commission to the advertising publisher based on the cookie.

20. A computer implemented system comprising:
means for advertising merchandise of a merchant to a user; and
means for auditing the merchant.
